(19) United States
(12) Patent Application Publication
(10) Pub. No.: US 2026/0268681 A1
(43) Pub. Date: Sep. 10, 2026

(54) REALTIME MULTI TRAILER COUPLER DETECTION

(71) Applicant: Continental Autonomous Mobility US, LLC, Auburn Hills, MI (US)

(72) Inventors: Eduardo Jose Ramirez Llanos, Rochester, MI (US); Angel Fernando Ceballos Espinoza, Santiago de Querétaro (MX)

(73) Assignee: Continental Autonomous Mobility US, LLC, Auburn Hills, MI (US)

(21) Appl. No.: 19/355,424

(22) Filed: Oct. 10, 2025

Related U.S. Application Data
(60) Provisional application No. 63/705,538, filed on Oct. 10, 2024.

(51) Int. Cl. G06V 20/56; G06V 10/25; G06V 10/26; G06V 10/764; G06V 10/82

(52) U.S. Cl. CPC G06V 20/56; G06V 10/25; G06V 10/26; G06V 10/764; G06V 10/82

(57) ABSTRACT

Real-time multi-trailer coupler detection is based on at least one image from a rear camera. A search region is defined. At least one trailer coupler is identified and localized via a detector that is a multi-task Convolutional Neural Network (CNN) that performs both classification and key-point detection simultaneously. A two-dimensional region of interest is divided into an outer grid of windows and an inner grid of windows, wherein a size of each window is the same as an input size of the detector, and wherein each window of the outer grid and the inner grid is an input for the detector. The inner grid of windows has one fewer row and one fewer column than the outer grid of windows. A sliding-window algorithm is applied to the outer and inner grids. Detections that surpass a confidence threshold are registered. Coupler predictions are filtered by calculating an overlap of close detections.

### TECHNICAL FIELD

This disclosure relates to a method and device for detecting the position of a tow ball of a tow vehicle for use, for example, during automated trailer hitching.

### BACKGROUND

Trailers are usually unpowered vehicles that are pulled by a powered tow vehicle. A trailer may be a utility trailer, a popup camper, a travel trailer, livestock trailer, flatbed trailer, enclosed car hauler, and boat trailer, among others. The tow vehicle may be a car, a crossover, a truck, a van, a sports-utility-vehicle (SUV), a recreational vehicle (RV), or any other vehicle configured to attach to the trailer and pull the trailer. The trailer may be attached to a powered vehicle using a trailer hitch. A receiver hitch mounts on the tow vehicle and connects to the trailer hitch to form a connection. The trailer hitch may be a ball and socket, a fifth wheel and gooseneck, or a trailer jack. Other attachment mechanisms may also be used.

Solving single detections of a coupler/trailer given a small region of interest to detect and track the coupler is known, while other solutions might rely on a two-stage process where the regions of interest are first look up over the whole image with an object detector, consequently a second algorithm/detector is used over that specific region to detect the coupler.

Improved techniques for identifying, in real time, multiple instances of coupler/trailer within a region of interest would advance the art.

### BRIEF SUMMARY

In accordance with at least one embodiment, real-time multi-trailer coupler detection is based on at least one image from a rear camera. A search region is defined. At least one trailer coupler is identified and localized via a detector that is a multi-task Convolutional Neural Network (CNN) that performs both classification and key-point detection simultaneously. A two-dimensional region of interest is divided into an outer grid of windows and an inner grid of windows, wherein a size of each window is the same as an input size of the detector, and wherein each window of the outer grid and the inner grid is an input for the detector. The inner grid of windows has one fewer row and one fewer column than the outer grid of windows. A sliding-window algorithm is applied to the outer and inner grids. Detections that surpass a confidence threshold are registered. Coupler predictions are filtered by calculating an overlap of close detections.

### BRIEF DESCRIPTION OF DRAWINGS

FIG. 1 is a schematic top view of an exemplary tow vehicle positioned in front of trailer.

FIG. 2 is a schematic view of an exemplary tow vehicle having a tow ball position calculator according to an example embodiment.

FIG. 3 depicts example maximum and minimum patch sizes, respectively, in accordance with at least one embodiment.

FIG. 4 depicts finding a depth limit of an area by knowing the minimal patch size in pixels, in accordance with at least one embodiment.

FIG. 5 depicts a region of interest that is a generally triangular-shaped polygon.

FIG. 6 is a powers-of-two table showing potential window sizes.

FIG. 7 depicts an example outer grid in accordance with at least one embodiment.

FIG. 8 depicts an example inner grid with one fewer row and column with than the outer grid.

FIG. 9 depicts a sliding-window algorithm that traverses a (n*m) grid by starting at the top-left corner and sliding a single-stage detector throughout each window, from left-to-right and top-to-bottom, in accordance with at least one embodiment.

FIG. 10 depicts an example input and output of non-max suppression.

FIG. 11 depicts an outer grid scan of an image from a vehicle's rear-view camera in accordance with at least one embodiment.

FIG. 12 depicts an inner grid scan of the image from the vehicle's rear-view camera in accordance with at least one embodiment.

FIG. 13 depicts a result of applying non-max suppression to the image of FIG. 12 in accordance with at least one embodiment.

FIG. 14 depicts an example heatmap representation in accordance with at least one embodiment.

FIG. 15 depicts a false positive in accordance with at least one embodiment.

FIG. 16 depicts results after training the network with true and false positives.

FIG. 17 is a flow chart depicting steps in accordance with at least one embodiment.

Like reference symbols in the various drawings indicate like elements.

### DETAILED DESCRIPTION

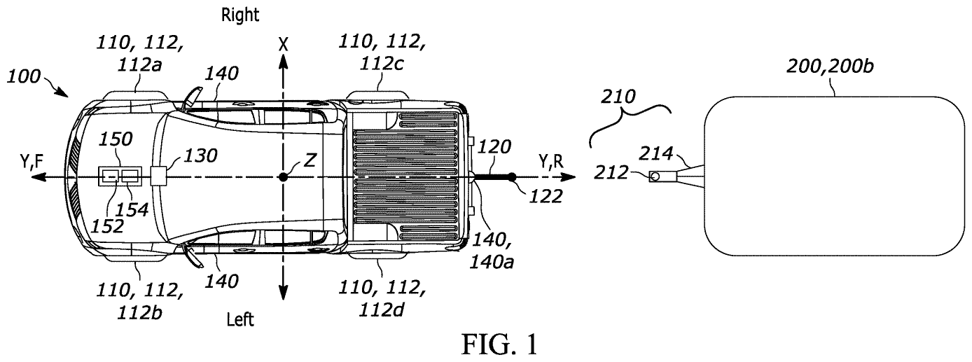

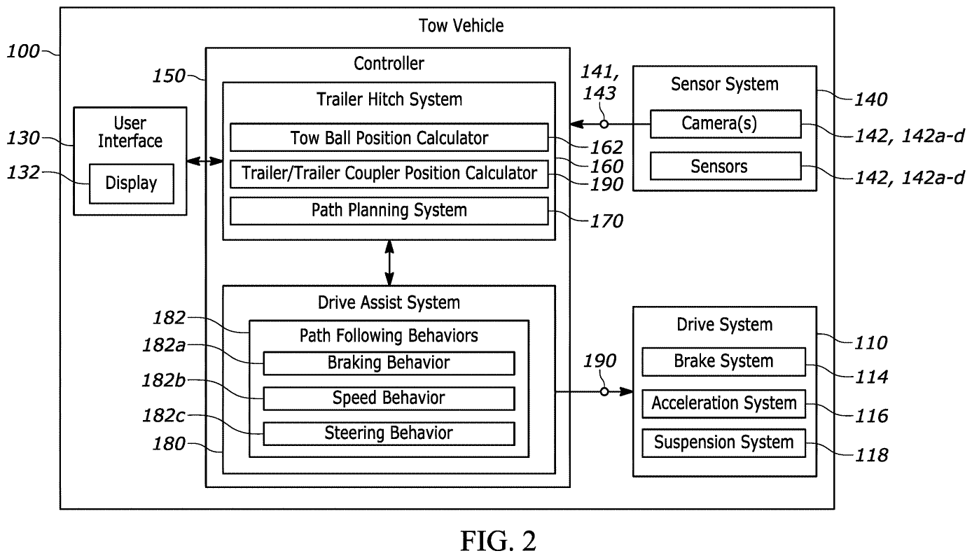

Referring to FIGS. 1 and 2, a tow vehicle 100, such as, but not limited to a car, a crossover, a truck, a van, a sports-utility-vehicle (SUV), and a recreational vehicle (RV) may be configured to hitch to and tow a trailer 200. The tow vehicle 100 connects to the trailer 200 by way of a tow vehicle hitch 120 having a tow vehicle tow ball 122 connecting to a trailer hitch 210 having a trailer coupler 212.

Referring to FIGS. 1-2, in some implementations, a driver of a tow vehicle 100 wants to tow a trailer 200 positioned behind the tow vehicle 100. In some examples, the driver maneuvers the tow vehicle 100 towards the trailer 200, while in other examples, the tow vehicle 100 autonomously drives towards the selected trailer 200. The tow vehicle 100 may include a drive system 110 that maneuvers the tow vehicle 100 across a road surface based on drive commands having x, y, and z components, for example. As shown, the drive system 110 includes a front right wheel 112, 112a, a front left wheel 112, 112b, a rear right wheel 112, 112c, and a rear left wheel 112, 112d. The drive system 110 may include other wheel configurations as well. The drive system 110 may also include a brake system 114 that includes brakes associated with each wheel 112, 112a-d, and an acceleration system 116 that is configured to adjust a speed and direction of the tow vehicle 100. In addition, the drive system 110 may include a suspension system 118 that includes tires associates with each wheel 112, 112a-d, tire air, springs, shock absorbers, and linkages that connect the tow vehicle 100 to its wheels 112, 112a-d and allows relative motion between the tow vehicle 100 and the wheels 112, 112a-d. The suspension system 118 may be configured to adjust a height of the tow vehicle 100 allowing a tow vehicle hitch 120 (e.g., a tow vehicle tow ball 122) to align with a trailer hitch 210 (e.g., trailer hitch coupler 212), which allows for autonomous connection between the tow vehicle 100 and the trailer 200.

The tow vehicle 100 may move across the road surface by various combinations of movements relative to three mutually perpendicular axes defined by the tow vehicle 100: a transverse axis X, a fore-aft axis Y, and a central vertical axis Z. The transverse axis X, extends between a right side and a left side of the tow vehicle 100. A forward drive direction along the fore-aft axis Y is designated as F, also referred to as a forward motion. In addition, an aft or rearward drive direction along the fore-aft direction Y is designated as R, also referred to as rearward motion. When the suspension system 118 adjusts the suspension of the tow vehicle 100, the tow vehicle 100 may tilt about the X axis and or Y axis, or move along the central vertical axis Z.

The tow vehicle 100 may include a user interface 130. The user interface 130 receives one or more user commands from the driver via one or more input mechanisms or a screen display 132 (for examples, a touch screen display) and/or displays one or more notifications to the driver. The user interface 130 is in communication with a vehicle controller 150, which is in turn in communication with a sensor system 140. In some examples, the user interface 130 displays an image of an environment of the tow vehicle 100 leading to one or more commands being received by the user interface 130 (from the driver) that initiate execution of one or more behaviors. In some examples, the user display 132 displays a representation 136 of a trailer 200 positioned behind the tow vehicle 100. The vehicle controller 150 includes a computing device (or processor or data processing hardware) 152 (e.g., central processing unit having one or more computing processors) in communication with non-transitory memory 154 (e.g., a hard disk, flash memory, random-access memory, memory hardware) capable of storing instructions executable on the computing processor(s) 152.

The tow vehicle 100 may include a sensor system 140 to provide reliable and robust driving. The sensor system 140 may include different types of sensors that may be used separately or with one another to create a perception of the environment of the tow vehicle 100 that is used for the tow vehicle 100 to drive and aid the driver in make intelligent decisions based on objects and obstacles detected by the sensor system 140. The sensor system 140 may include the one or more cameras 142. In some implementations, the tow vehicle 100 includes a rear camera 142a that is mounted to provide images 143 of a rear view of the tow vehicle 100. The rear camera 142a may include a fisheye lens that includes an ultra wide-angle lens that produces strong visual distortion intended to create a wide panoramic or hemispherical image 143. Fisheye cameras capture images 143 having an extremely wide angle of view. Moreover, images 143 captured by the fisheye camera have a characteristic convex non-rectilinear appearance. Other types of cameras may also be used to capture images 143 of the rear-driving path of the tow vehicle 100.

The sensor system 140 may include other sensors such as, but not limited to, radar, sonar, LIDAR (Light Detection and Ranging, which can entail optical remote sensing that measures properties of scattered light to find range and/or other information of a distant target), LADAR (Laser Detection and Ranging), ultrasonic sensors, stereo cameras, etc.

The controller 150 may execute a trailer coupler position calculator algorithm or module 190 for determining the position of a trailer coupler 212 of a trailer relative to a reference frame. The trailer coupler position calculator 190 may be associated with or otherwise part of a trailer hitch system 160 for autonomously or semi-autonomously maneuvering and positioning the tow ball of the tow vehicle 100 relative to the coupler of the trailer 200. The trailer hitch system 160 may include a number of modules and/or algorithms in carrying out various trailer hitching functions. Accurately determining the position of the trailer coupler 210 advantageously allows for precise positioning of the tow ball 122 relative to the trailer coupler 212 for more effectively performing a trailer hitching operation.

As mentioned, the trailer hitch system 160 may include other algorithms and/or modules for supporting trailer hitch functions. Each algorithm/module may include instructions which, when executed by the vehicle controller 150, causes the vehicle controller to perform one or more trailer hitch functions. For instance, trailer hitch system 160 may include an algorithm or module which detects and determines the position of the trailer coupler 212, and a path planning algorithm or module which determines a path for the tow vehicle 100 based at least in part upon the determined position of the vehicle tow ball 122 and the trailer coupler 212.

In accordance with at least one embodiment, a single stage detector is used to solve both single and multiple detections. At least one image, which comes from a rear camera of the tow vehicle and that observes the trailers within a specific region, is used.

The algorithm proposed involves camera calibration (intrinsic and extrinsic) and a coupler detector. By default, a coupler is an object with a small volume, therefore depending on the camera characteristics, the visibility of this object will determine the search region. Once the limit of the region is determined, this space is divided into smaller chunks (also referred to herein as smaller regions or windows) proportional to the detector input. By doing so, windows with certain features of the scene are created. The chunks of the scene are then used either for training the detector or inferring. These windows may contain features from the coupler/trailer or anything else within the scene, so the labels have a positive or negative tag (e.g., 1.0=max confidence, 0.0=min confidence). The sliding window algorithm starts from the top-left corner of the region and traverses it left-to-right and top-to-bottom. Scanning the area produces probabilities of a coupler instance with respect to each window. Then, a filtering algorithm is applied to retrieve the most significant detections.

### Inputs:

Rear camera view (at least one image).
Camera intrinsic and extrinsic parameters.

### Outputs:

A list of 2D points (x, y) describing the position of couplers detected within the image ROI.

### Method:

### Definition of the Search Region:

Step 1.a.: The coupler of a trailer is a relatively small object that can be modeled as a sphere. The patch size of this sphere will vary depending on how far or how close the object is from the camera reference. To find the max patch size of the coupler we can take the hitch position as reference, but for the min patch size it is a different case. Theoretically, the coupler/trailer can be infinitely far away from the camera which would lead to a patch size of less than one pixel. We know this case would be impossible to solve for a detector as almost no data is available. Therefore, a minimal patch size of five pixels by five pixels is used as reference, based on the current capacities of Convolutional Neural Network (CNN) detectors. Other suitable minimal patch sizes could also be used.

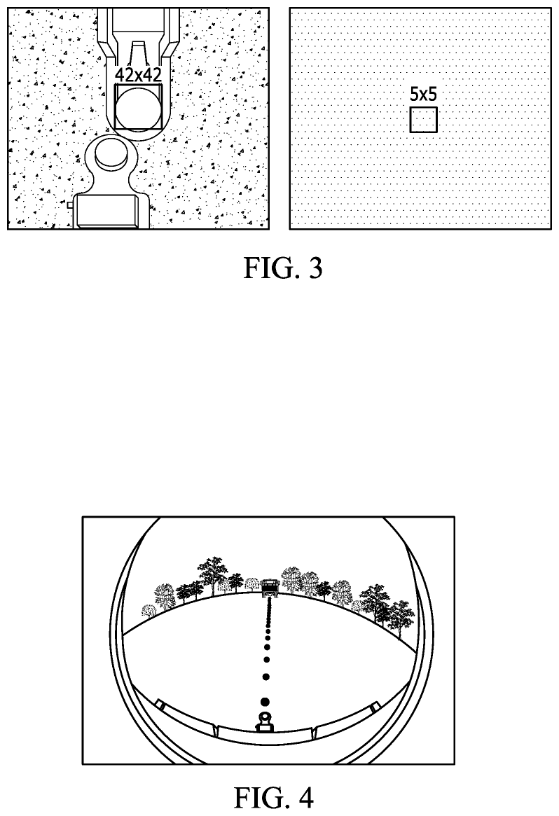

FIG. 3 depicts example maximum and minimum patch size, respectively, in accordance with at least one embodiment. The example maximum patch size on the left-hand side of FIG. 3 is 42×42, and the example minimum patch size on the right hand side of FIG. 3 is 5×5. Other suitable maximum and minimum patch sizes could also be used.

As depicted in FIG. 4, in Step 1.b., by knowing the minimal patch size in pixels, it is possible to find the depth limit of the area by projecting multiple instances of an object, e.g., a sphere, (along a ray) and measuring the respective patch size (in pixels, for instance) of each of the instances of the projected object. In an example, the max depth determined for patch size of 5 pixels by 5 pixels was between 7-8 meters.

In Step 1.c., once the max depth for searching the coupler is known, we can define a region for initial coupler scan. For this, think of rotating the ray to cover a larger area, in an example, we used 360 but it can be any other angle depending on the use case. Subsequently, from the 3D scan area, we obtain a 2D region of interest.

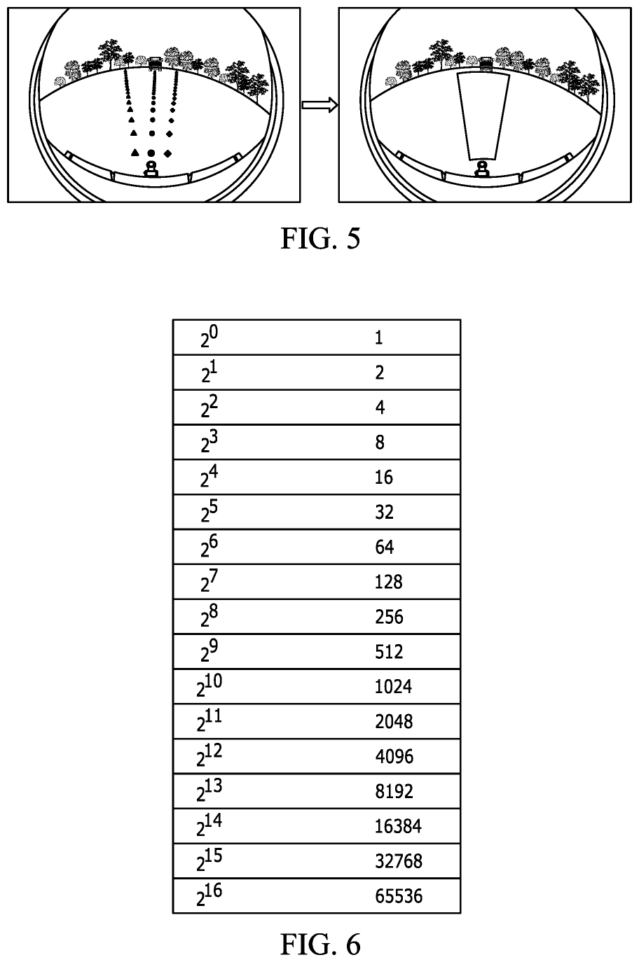

As depicted in FIG. 5, in an example, our solution creates a triangular looking polygon, but it could any other shape like a rectangle to search just at the center.

Multiple Coupler Identification and localization:

From Step 1.a., we know that the maximum coupler patch size is approximately 42 pixels by 42 pixels at depth=min_value. This information is useful for selecting the input size of the detector. Typically, the input size of a CNN is n², we could choose a crop size of 64 pixels, but this window size could be easily saturated by a larger or closer coupler. The next best input size then would be 128×128. This will be our example window size for the next steps. Other example window sizes are shown in FIG. 6.

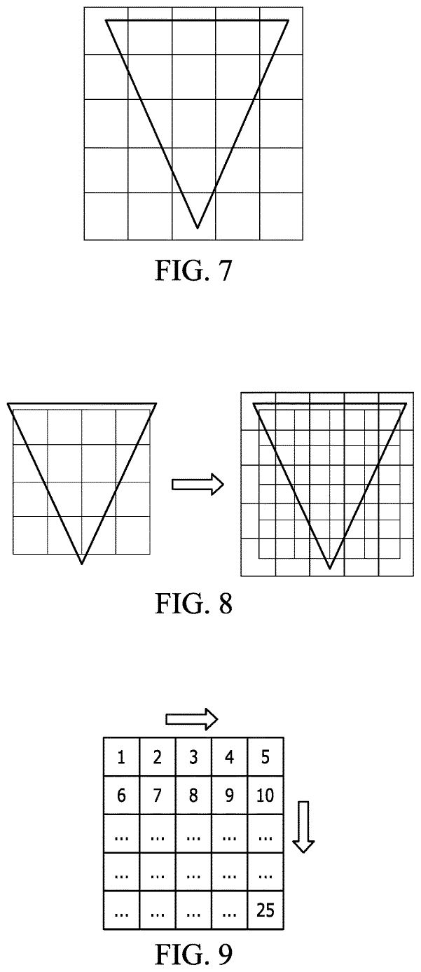

Based on the detector input size, divide the search area defined at step 1.c. into smaller chunks (128×128 windows). The windows should cover the defined Region of Interest (ROI) (e.g., the triangular-looking polygon on the right-hand side in FIG. 5) if not slightly more, so that no data is missed. This tiled area is known as the outer grid, which is depicted in FIG. 7, and each window is an input for the detector.

Since a coupler may be located at the perimeter of a window, which is also the intersection of the neighboring windows, the CNN could miss a detection. To address this issue, we create an inner grid with one fewer row and column with respect to the outer grid, as depicted in FIG. 8. The top-left corner of the inner grid should lie at the center of the first window of the outer grid and end at the center of the last window. By doing so, you cover the blind spots.

A sliding-window algorithm works by traversing a (n*m) grid. Starting at the top-left corner, we slide a single-stage detector throughout each window, from left-to-right and top-to-bottom, as depicted in FIG. 9. A batch inference could be done instead of one-by-one detection.

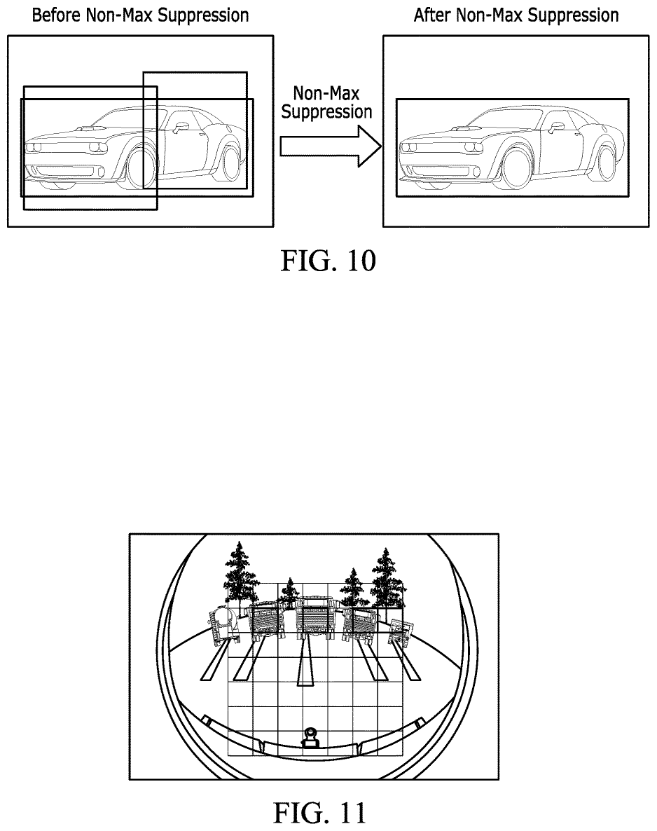

We apply the sliding window algorithm to the outer and inner grid. We register the detections that surpass a confidence threshold (e.g., 0.7). Other suitable thresholds could also be used. Finally, we filter the coupler predictions by calculating the overlap of close detections and determine the likelihood of them being the same or distinct couplers. Filtering in this way is known as non-max suppression. An example input and output of non-max suppression is depicted in FIG. 10. As used in this context, the term “close” refers to detections located near one another. There is a probability that the same object is detected via both the outer and inner grids. In such a case, both detections will be very close or overlap, which then can be turned into a single detection (e.g., by choosing the one with the higher confidence).

FIG. 11 depicts an outer grid scan of an image from a vehicle's rear-view camera in accordance with at least one embodiment. As shown in FIG. 11, four of the 49 windows are highlighted in green to indicate that there is a high confidence of a trailer/coupler detected in those four highlighted boxes.

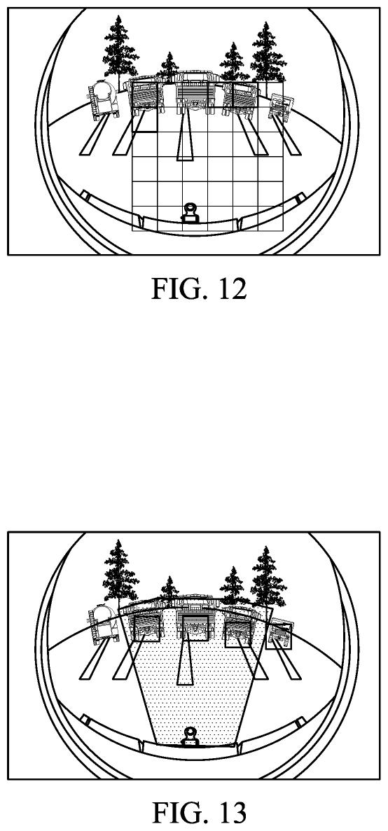

FIG. 12 depicts an inner grid scan of the image from the vehicle's rear-view camera in accordance with at least one embodiment. As shown in FIG. 12, four of the 36 windows are highlighted in green to indicate that there is a high confidence of a trailer/coupler detected in those four highlighted boxes.

In accordance with at least one embodiment, applying the sliding window algorithm to the outer and inner grid is not a two-step process. Instead, the two grids may both be traversed in a single pass. In other words, there may be a single list of areas to be scanned. In order to better explain the scan process, it has been explained in terms the inner and outer grids to understand the purpose of the scan process.

In contrast to the sliding window algorithm, in the context of detection of a trailer coupler from images of a rear-view camera of a vehicle, a conventional 2-stage algorithm would first use an object detector to detect the whole trailer (or the area close to the coupler), then a second network would be used for estimating its keypoints/center. Advantageously, in accordance with at least one embodiment of the invention, the sliding window algorithm is applied to both the outer and inner grid via a single pass.

FIG. 13 depicts a result of applying non-max suppression to the image of FIG. 12 in accordance with at least one embodiment.

### Multi-Task CNN:

In accordance with at least one embodiment, our detector is a multi-task Convolutional Neural Network (CNN) that performs both classification and key-point detection simultaneously. For each input window, the network produces two outputs: (1) a classification score, indicating the presence of a coupler; and a set of N heatmaps, where each heatmap corresponds to a specific key-point of the coupler.

The location of a key-point is encoded as the maximum peak of a 2D Gaussian function within its respective heatmap. Classification is implicitly handled through this process: crops containing a coupler (true positives) are trained with heatmaps showing Gaussian peaks at the key-point locations, while crops without a coupler (true negatives/false positives) are trained with empty heatmaps (zero magnitude). This teaches the network to generate peaks when a coupler is actually present and not to generate peaks when a coupler is not present.

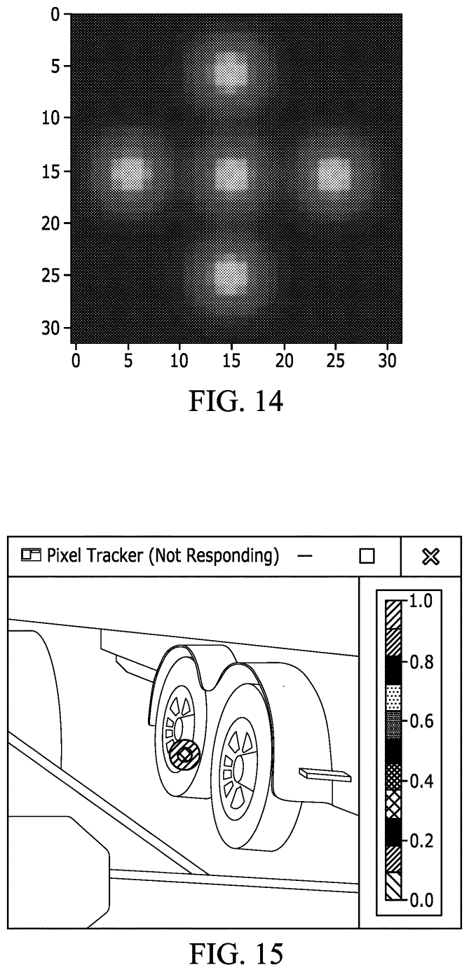

FIG. 14 depicts an example heatmap representation in accordance with at least one embodiment. FIG. 14 is an example of how the network's output may look. It is a heatmap with maximums at the estimated (x, y) coordinates related to each keypoint (5 of which are depicted in FIG. 14).

FIG. 15 depicts a false positive in accordance with at least one embodiment. FIG. 15 is an example of a false positive detection, which we then take as an example to train the network. Basically, the initial network sees it and thinks that it is a coupler, but that is false. So, we do take that crop with the false positive and add it to the negative examples of our dataset thereby retraining the network to provide an empty map (with no peaks) for that case.

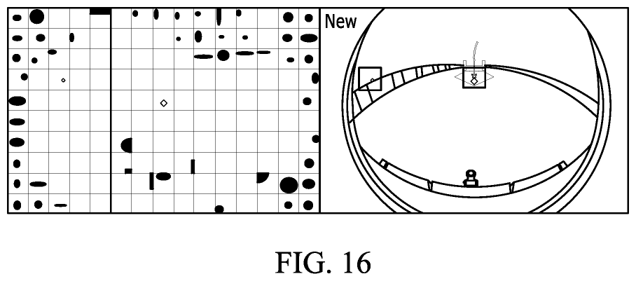

FIG. 16 depicts results after training the network with true and false positives. FIG. 16 depicts a scanning of the whole image looking for true positives (coupler) and any false positives. The whole image is divided by squares that are the size of the input of the network (128×128). The blue color is a very low confidence, the black is confidence=0 and the red is high confidence.

A suitable example non-max suppression algorithm is:

Algorithm 1 Non-Max Suppression

| | |
|---|---|
| 1: | procedure NMS(B,c) |
| 2: | Bₙₘₛ ← ∅ |
| 3: | for bᵢ ∈ B do |
| 4: | discard ← False |
| 5: | for bⱼ ∈ B do |
| 6: | if same(bᵢ, bⱼ) > λₙₘₛ then |
| 7: | if score(c, bⱼ) > score(c, bᵢ) then |
| 8: | discard ← True |
| 9: | if not discard then |
| 10: | Bₙₘₛ ← Bₙₘₛ ∪ bᵢ |
| 11: | return Bₙₘₛ |

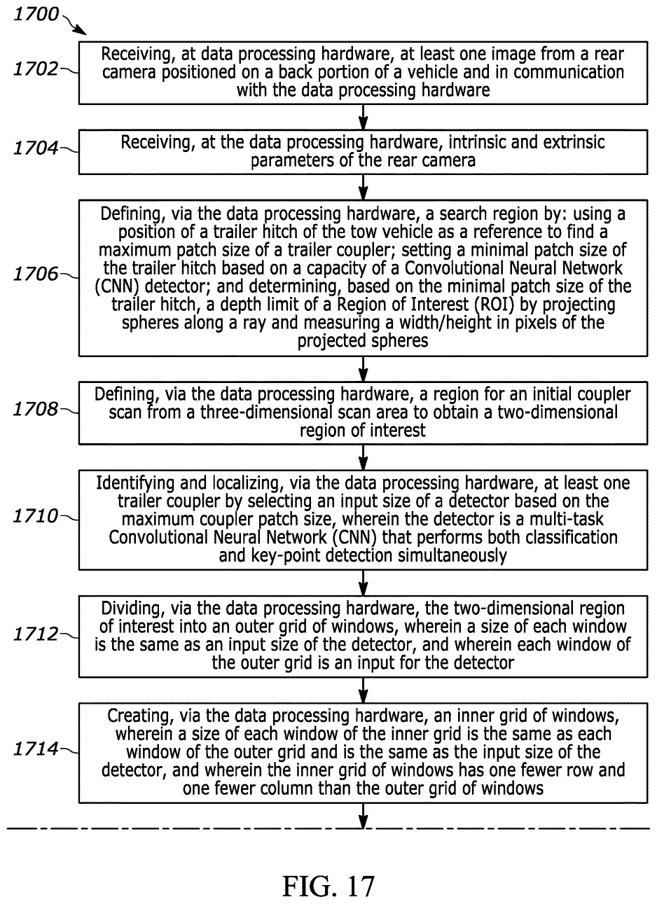

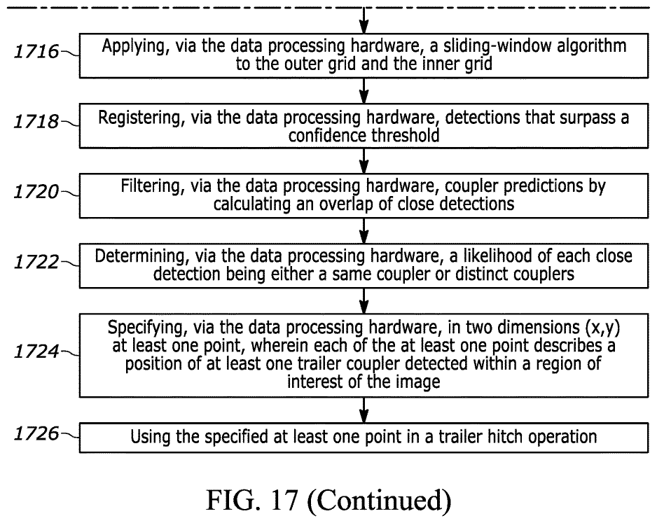

FIG. 17 is a flow chart 1700 depicting steps in accordance with at least one embodiment. Step 1702 depicts receiving, at data processing hardware, at least one image from a rear camera positioned on a back portion of a vehicle and in communication with the data processing hardware. Step 1704 depicts receiving, at the data processing hardware, intrinsic and extrinsic parameters of the rear camera. Step 1706 depicts defining, via the data processing hardware, a search region by: using a position of a trailer hitch of the tow vehicle as a reference to find a maximum patch size of a trailer coupler; setting a minimal patch size of the trailer hitch based on a capacity of a Convolutional Neural Network (CNN) detector; and determining, based on the minimal patch size of the trailer hitch, a depth limit of a Region of Interest (ROI) by projecting spheres along a ray and measuring a width/height in pixels of the projected spheres. Step 1708 depicts defining, via the data processing hardware, a region for an initial coupler scan from a three-dimensional scan area to obtain a two-dimensional region of interest. Step 1710 depicts identifying and localizing, via the data processing hardware, at least one trailer coupler by selecting an input size of a detector based on the maximum coupler patch size, wherein the detector is a multi-task Convolutional Neural Network (CNN) that performs both classification and key-point detection simultaneously. Step 1712 depicts dividing, via the data processing hardware, the two-dimensional region of interest into an outer grid of windows, wherein a size of each window is the same as an input size of the detector, and wherein each window of the outer grid is an input for the detector. Step 1714 depicts creating, via the data processing hardware, an inner grid of windows, wherein a size of each window of the inner grid is the same as each window of the outer grid and is the same as the input size of the detector, and wherein the inner grid of windows has one fewer row and one fewer column than the outer grid of windows. Step 1716 depicts applying, via the data processing hardware, a sliding-window algorithm to the outer grid and the inner grid. Step 1718 depicts registering, via the data processing hardware, detections that surpass a confidence threshold. Step 1720 depicts filtering, via the data processing hardware, coupler predictions by calculating an overlap of close detections. Step 1722 depicts determining, via the data processing hardware, a likelihood of each close detection being either a same coupler or distinct couplers. Step 1724 depicts specifying, via the data processing hardware, in two dimensions (x, y) at least one point, wherein each of the at least one point describes a position of at least one trailer coupler detected within a region of interest of the image. And step 1726 depicts using the specified at least one point in a trailer hitch operation.

At least one embodiment performs detection of multiple instances of a trailer/coupler more efficiently than conventional techniques because it is based on a single-instance detector that slides across a region. Stated differently, at least one embodiment searches for couplers over a region and tracks the selected instance over time, with the same detector.

Relative to the prior art, at least one embodiment achieves functional advantages including providing multi-trailer scalability, coupler-specific precision, and real-time performance.

In an example embodiment, the trailer coupler position calculator 190 receives as input at least one image 143 from the rear camera 142a, and intrinsic and extrinsic parameters of the rear camera. The intrinsic and extrinsic parameters may include camera type, such as pinhole; image width and height; principle x- and y-axes; the focal length; the position (x, y, z) of the rear camera 142a relative to, for example, a center location along the rear axle of the tow vehicle 100; the center of the image array; and the rotation or orientation (yaw, pitch, and roll) of the rear camera. The parameters of the rear camera 142a may be maintained in memory 154 and retrieved by the vehicle controller 150 as needed.

The trailer coupler position calculator 190 may additionally receive as input a size of the tow ball 122. Tow balls are known to be in any of three possible common sizes—small, medium and large—such that the tow ball position calculator 152 receives as input one of the three sizes. The tow ball size may be provided by the tow vehicle operator via the user interface or maintained in memory 154 and retrieved by the vehicle controller 150. With the captured rear camera image 143, the rear camera parameters and the size of the tow ball 142a, the tow ball position calculator 162 determines the position of the tow ball 142 (x, y, z) for subsequent use in, for example, carrying out one or more trailer hitch functions by the vehicle controller 150.

It is understood that the trailer coupler position calculator 190 may be configured based upon geographical region as to the common tow ball size(s) for that region. In this case, the trailer coupler position calculator 190 may be configured to accept in the U.S. a tow ball size from three common sizes and may be configured to accept one or more possible common sizes in another geographical region that are different from the common US sizes, such as Europe and/or one or more European countries. Further, the trailer coupler position calculator 190 may also receive as input a specific tow ball size provided by tow vehicle user or as retrieved from memory that does not correspond to a common size, which may find use in geographical regions in which there is no common size.

The operation of the trailer coupler position calculator 190 will be described with respect to FIGS. 3-17. The trailer coupler position calculator 190 may be activated as part of the activation of a trailer hitch function, such as a request to perform a trailer hitch assist operation. Once activated, the trailer coupler position calculator 190, and in particular the vehicle controller 150, receives one or more images captured by the rear camera 142a.

Next, the vehicle controller 150 receives at 504 intrinsic and extrinsic parameters of the rear camera 142a. These may be retrieved from memory 154 and/or provided from the tow vehicle user via the user interface 130. At 506, the vehicle controller 150, when executing the trailer coupler position calculator algorithm 190, identifies at 506 a representation of the trailer coupler 210 in the image(s) captured by the rear camera 142a. This step may be performed using any of a number of known approaches for detecting an object in image data. For example, the trailer coupler representation may be identified via edge detection and/or contour analysis. Specifically, edge detection may be used to identify the boundary between the representation of the coupler 212 and other objects in the image data. In an implementation, a Canny edge detection algorithm identifies the boundary of the coupler 212. Further, a contour detection algorithm may be employed to find contours in the edge-detected image for locating the outer edge of the coupler image representation. This may include selecting the contour that represents or best represents the interface or intersection between the coupler 212 and other objects in the depicted scene in the image(s). In addition, a line or curve through the points in the image that are along the outer edge of the coupler representation may be identified in identifying the coupler 212.

Alternatively, the coupler 212 may be detected using a texture and/or gradient based analysis. Specifically, the trailer coupler position calculator 190 may employ texture analysis using descriptors on the rear camera image(s). This analysis analyzes the texture differences between the representation of the coupler 210 in the image and surrounding objects in the captured scene using texture descriptors, such as Local Binary Patterns (LBP). Differences in texture are used in distinguishing the coupler representation from the representation of other objects in the image when color differences therebetween are negligible. Computing the magnitude and direction of an image gradient serves to identify areas of the image with substantial changes in intensity. The boundary between the coupler 212 and surrounding objects may show distinct gradient patterns which may be used to identify representation of the coupler 212. Peaks in the gradient magnitude along the coupler boundary in the image data additionally or alternatively be used to identify the coupler representation in the captured rear camera image.

One or more example embodiments of the trailer coupler position calculator 190 may utilize a trained neural network and/or AI-generated model for use in identifying the trailer coupler representation in the captured rear camera image. The trained neural network and/or AI-generated model may utilize semantic segmentation and classification to identify the trailer coupler representation. One or more deep learning models may be trained specifically to segment the representation of trailer coupler 210 from other objects appearing in the image. The deep learning model may have an architecture or framework such as, for example, Segformer, U-Net, Mask R-CNN (Region-based Convolutional Neural Network). After segmentation of the image, the trained neural network/model 156 extracts the trailer coupler representation from the generated segmentation mask to detect and/or identify the boundary of the tow ball representation.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus,” “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims.

1. A method of real-time multi-trailer coupler detection, the method comprising:
receiving, at data processing hardware, at least one image from a rear camera positioned on a back portion of a vehicle and in communication with the data processing hardware;
receiving, at the data processing hardware, intrinsic and extrinsic parameters of the rear camera;
defining, via the data processing hardware, a search region by:
using a position of a trailer hitch of the tow vehicle as a reference to find a maximum path size of a trailer coupler;
setting a minimal patch size of the trailer hitch based on a capacity of a Convolutional Neural Network (CNN) detector;
determining, based on the minimal patch size of the trailer hitch, a depth limit of a Region of Interest (ROI) by projecting spheres along a ray and measuring a width/height in pixels of the projected spheres;
defining, via the data processing hardware, a region for an initial coupler scan from a three-dimensional scan area to obtain a two-dimensional region of interest;
identifying and localizing, via the data processing hardware, at least one trailer coupler by selecting an input size of a detector based on the maximum coupler patch size, wherein the detector is a multi-task Convolutional Neural Network (CNN) that performs both classification and key-point detection simultaneously;
dividing, via the data processing hardware, the two-dimensional region of interest into an outer grid of windows, wherein a size of each window is the same as an input size of the detector, and wherein each window of the outer grid is an input for the detector;
creating, via the data processing hardware, an inner grid of windows, wherein a size of each window of the inner grid is the same as each window of the outer grid and is the same as the input size of the detector, and wherein the inner grid of windows has one fewer row and one fewer column than the outer grid of windows;
applying, via the data processing hardware, a sliding-window algorithm to the outer grid and the inner grid;
registering, via the data processing hardware, detections that surpass a confidence threshold;
filtering, via the data processing hardware, coupler predictions by calculating an overlap of close detections;
determining, via the data processing hardware, a likelihood of each close detection being either a same coupler or distinct couplers;
specifying, via the data processing hardware, in two dimensions (x, y) at least one point, wherein each of the at least one point describes a position of at least one trailer coupler detected within a region of interest of the image; and
using the specified at least one point in a trailer hitch operation.

2. The method of claim 1, wherein the two-dimensional region of interest is a polygon.

3. The method of claim 2, wherein the polygon is substantially triangular-shaped.

4. The method of claim 3, wherein the substantially triangular-shaped polygon includes an angle of approximately 36 degrees.

5. The method of claim 1, wherein, for each input window, the multi-task CNN produces two outputs:
a classification score, indicating a presence of at least one trailer coupler; and
a set of N heatmaps, where each heatmap corresponds to a specific key-point, in the at least one image, of the at least one coupler.

6. The method of claim 5, wherein a location of a key-point is encoded as a maximum peak of a two-dimensional Gaussian function within the key-point's corresponding heatmap.

7. The method of claim 6, wherein classification is performed by crops containing a coupler (true positives) being trained with heatmaps showing Gaussian peaks at the key-point locations, while crops without a coupler (true negatives/false positives) are trained with empty heatmaps (zero magnitude) thereby teaching the multi-task CNN to generate peaks when a coupler is present and not to generate peaks when a coupler is not present.

8. The method of claim 1, wherein a top-left corner of the inner grid is centered within a top-left window of the outer grid, and a bottom-right corner of the inner grid is centered within a bottom-right window of the outer grid thereby covering any blind spots within the outer grid.

9. The method of claim 1, wherein the filtering coupler predictions and determining a likelihood of same or distinct couplers is performed via non-max suppression.

10. The method of claim 1, wherein the sliding-window algorithm is applied to both the outer grid and the inner grid in a single pass.

11. A non-transitory computer-readable medium, having stored thereon computer-executable instructions that, when executed by at least one processor, cause performance of real-time multi-trailer coupler detection, via operations comprising:
receiving, at data processing hardware, at least one image from a rear camera positioned on a back portion of a vehicle and in communication with the data processing hardware;
receiving, at the data processing hardware, intrinsic and extrinsic parameters of the rear camera;
defining, via the data processing hardware, a search region by:
using a position of a trailer hitch of the tow vehicle as a reference to find a maximum patch size of a trailer coupler;
setting a minimal patch size of the trailer hitch based on a capacity of a Convolutional Neural Network (CNN) detector;
determining, based on the minimal patch size of the trailer hitch, a depth limit of a Region of Interest (ROI) by projecting spheres along a ray and measuring a width/height in pixels of the projected spheres;
defining, via the data processing hardware, a region for an initial coupler scan from a three-dimensional scan area to obtain a two-dimensional region of interest;
identifying and localizing, via the data processing hardware, at least one trailer coupler by selecting an input size of a detector based on the maximum coupler patch size, wherein the detector is a multi-task Convolutional Neural Network (CNN) that performs both classification and key-point detection simultaneously;
dividing, via the data processing hardware, the two-dimensional region of interest into an outer grid of windows, wherein a size of each window is the same as an input size of the detector, and wherein each window of the outer grid is an input for the detector;
creating, via the data processing hardware, an inner grid of windows, wherein a size of each window of the inner grid is the same as each window of the outer grid and is the same as the input size of the detector, and wherein the inner grid of windows has one fewer row and one fewer column than the outer grid of windows;
applying, via the data processing hardware, a sliding-window algorithm to the outer grid and the inner grid;
registering, via the data processing hardware, detections that surpass a confidence threshold;
filtering, via the data processing hardware, coupler predictions by calculating an overlap of close detections;
determining, via the data processing hardware, a likelihood of each close detection being either a same coupler or distinct couplers;
specifying, via the data processing hardware, in two dimensions (x, y) at least one point, wherein each of the at least one point describes a position of at least one trailer coupler detected within a region of interest of the image; and
using the specified at least one point in a trailer hitch operation.

12. The non-transitory computer-readable medium of claim 11, wherein the two-dimensional region of interest is a polygon.

13. The non-transitory computer-readable medium of claim 12, wherein the polygon is substantially triangular-shaped.

14. The non-transitory computer-readable medium of claim 13, wherein the substantially triangular-shaped polygon includes an angle of approximately 36 degrees.

15. The non-transitory computer-readable medium of claim 11, wherein, for each input window, the multi-task CNN produces two outputs:
a classification score, indicating a presence of at least one trailer coupler; and
a set of N heatmaps, where each heatmap corresponds to a specific key-point, in the at least one image, of the at least one coupler.

16. The non-transitory computer-readable medium of claim 15, wherein a location of a key-point is encoded as a maximum peak of a two-dimensional Gaussian function within the key-point's corresponding heatmap.

17. The non-transitory computer-readable medium of claim 16, wherein classification is performed by crops containing a coupler (true positives) being trained with heatmaps showing Gaussian peaks at the key-point locations, while crops without a coupler (true negatives/false positives) are trained with empty heatmaps (zero magnitude) thereby teaching the multi-task CNN to generate peaks when a coupler is present and not to generate peaks when a coupler is not present.

18. The non-transitory computer-readable medium of claim 11, wherein a top-left corner of the inner grid is centered within a top-left window of the outer grid, and a bottom-right corner of the inner grid is centered within a bottom-right window of the outer grid thereby covering any blind spots within the outer grid.

19. The non-transitory computer-readable medium of claim 11, wherein the filtering coupler predictions and determining a likelihood of same or distinct couplers is performed via non-max suppression.

20. The non-transitory computer-readable medium of claim 11, wherein the sliding-window algorithm is applied to both the outer grid and the inner grid in a single pass.
